(19) United States
(12) Patent Application Publication
(10) Pub. No.: US 2017/0327263 A1
(43) Pub. Date: Nov. 16, 2017

(54) MULTI-USER BOTTLE

(71) Applicants: Robin Elaine Haar, North Hollywood, CA (US); Annette Marie Amstutz, Northridge, CA (US)

(72) Inventors: Robin Elaine Haar, North Hollywood, CA (US); Annette Marie Amstutz, Northridge, CA (US)

(21) Appl. No.: 15/153,057

(22) Filed: May 12, 2016

(51) Int. Cl. B65D 1/04; B65D 41/04; A01K 7/00

(52) U.S. Cl. CPC B65D 1/04; A01K 7/00; B65D 41/04

(57) ABSTRACT

A multi-user bottle including a fluid storage chamber, an opening to the fluid storage chamber, and an attachment to a detachable fluid reservoir apart from the opening. The bottle may include the detachable fluid reservoir. In some aspects, the attachment to the detachable fluid reservoir is on an opposite side of the bottle from the opening. Preferably, the detachable fluid reservoir, when attached, cannot contaminate the opening. The fluid storage chamber may also include detachable section to facilitate filling of the bottle.

### CROSS-REFERENCE TO RELATED APPLICATION

Not applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND

The present disclosure generally relates to a multi-user water (or other liquid) bottle, for example by use with a person and his or her pet.

### SUMMARY

Aspects of the subject technology include a multi-user bottle with a fluid storage chamber, an opening to the fluid storage chamber, and an attachment to a detachable fluid reservoir apart from the opening. The bottle may include the detachable fluid reservoir. In some aspects, the attachment to the detachable fluid reservoir is on an opposite side of the bottle from the opening. Preferably, the detachable fluid reservoir, when attached, cannot contaminate the opening. The fluid storage chamber may also include detachable section to facilitate filling of the bottle.

This brief summary has been provided so that the nature of the invention may be understood quickly. Additional steps and/or different steps than those set forth in this summary may be used. A more complete understanding of the invention may be obtained by reference to the following description in connection with the attached drawing.

### BRIEF DESCRIPTION OF THE DRAWINGS

FIG. 1 illustrates a bottle according to aspects of the subject technology.

### DETAILED DESCRIPTION

Briefly, aspects of the subject technology include a bottle with a fluid storage chamber, an opening to the fluid storage chamber, and an attachment to a detachable fluid reservoir apart from the opening. The bottle may include the detachable fluid reservoir. In some aspects, the attachment to the detachable fluid reservoir is on an opposite side of the bottle from the opening. Preferably, the detachable fluid reservoir, when attached, cannot readily contaminate the opening. The fluid storage chamber may also include one or more detachable section to facilitate filling of the bottle.

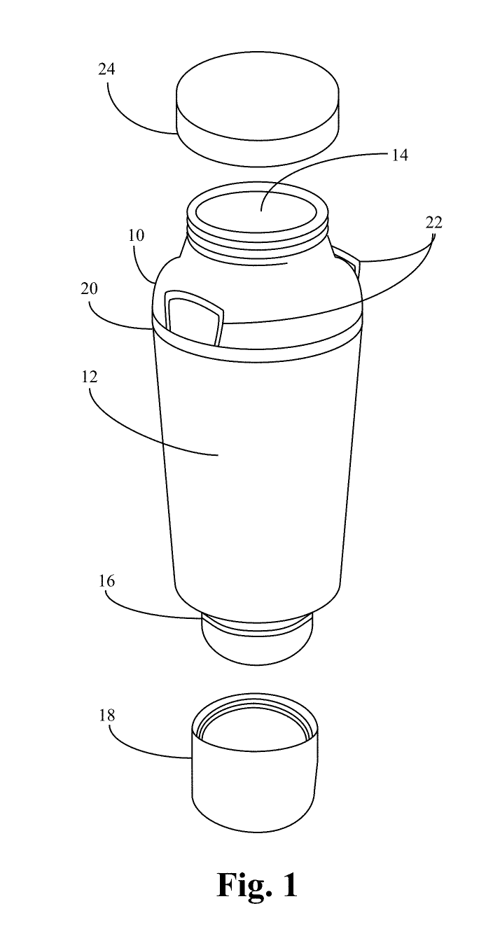

In more detail, FIG. 1 shows multi-user bottle 10 with fluid storage chamber 12, for example for water, sports drinks, or the like. The bottle includes opening 14 for drinking from the bottle.

The bottle also includes attachment 16 for detachable fluid reservoir 18. In FIG. 1, attachment 16 is shown as a threaded (e.g., screw-on) component opposite from opening 14. Other attachments may be used, for example but not limited to pressure fitted section(s), ridges, hook-and-loop fasteners, or the like. Furthermore, the attachment may be located at another place on the bottle.

In use, a person may detach the detachable fluid reservoir in order to provide fluid to a pet, friend, child, other person, other animal, or the like. Because detachable fluid reservoir 18 does not have to contact opening 14, the sanitary state of fluid storage chamber 12 may be preserved.

Ridge 20 may be included to enhance structural integrity for carrying the bottle with a strap connected to handles 22. In other aspects, ridge 20 may represent a break-line for opening the water bottle in order to allow for quicker filling and/or cleaning. In further aspects, ridge 20 and/or handles 22 may be omitted.

Screw-on or otherwise attachable cap 24 may also be provided to seal opening 14.

The multi-user bottle according to aspects of the subject technology and associated components such as detachable fluid reservoir 18 and cap 24 may be made of any suitably strong and fluid-resistant material. Examples include but are not limited to plastic, rubber, polyurethane, polyethylene, aluminum, steel, other metals, and the like.

The invention is in no way limited to the specifics of any particular embodiments and examples disclosed herein. For example, the terms “aspect,” “example,” “preferably,” “alternatively,” and the like denote features that may be preferable but not essential to include in some embodiments of the invention. Many other variations are possible which remain within the content, scope, and spirit of the invention, and these variations would become clear to those skilled in the art after perusal of this application.

What is claimed is:

1. A multi-user bottle comprising:
a fluid storage chamber;
an opening to the fluid storage chamber; and
an attachment to a detachable fluid reservoir apart from the opening.

2. A multi-user bottle as in claim 1, further comprising the detachable fluid reservoir.

3. A multi-user bottle as in claim 1, wherein the attachment to the detachable fluid reservoir is on an opposite side of the bottle from the opening.

4. A multi-user bottle as in claim 1, wherein the detachable fluid reservoir, when attached, cannot contaminate the opening.

5. A multi-user bottle as in claim 1, wherein the fluid storage chamber further comprises a detachable section to facilitate filling of the bottle.
